(19) United States
(12) Patent Application Publication
(10) Pub. No.: US 2007/0293396 A1
(43) Pub. Date: Dec. 20, 2007

(54) Suspoemulsions Comprising an Hppd-Inhibiting and a Chloracetamide Herbicide

(75) Inventors: Hans Walter Haesslin, Muenchwilen (CH); Derek John Hopkins, Muenchwilen (CH); Frederique Guyon, Muenchwilen (CH); Angelika Haesslin, Muenchwilen (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 10/598,809

(22) PCT Filed: Mar. 3, 2005
(86) PCT No.: PCT/EP05/02229

§ 371 Date: Jul. 2, 2007

(30) Foreign Application Priority Data
Mar. 15, 2004 (GB) 0405760.0

(51) Int. Cl. A01N 25/32; A01N 43/36; A01N 43/40; A01P 13/00

(52) U.S. Cl. 504/103; 504/130; 504/138

(57) ABSTRACT

A chemically and physically stable suspoemulsion formulation, free from polymeric stabilisers having a molecular weight of between 10,000 and 1,000,000 daltons, comprising: (i) a continuous phase, (ii) an HPPD-inhibiting herbicide insoluble in the continuous phase, (iii) a chloroacetamide, and (iv) one or more aromatic ethoxylate compounds or derivatives thereof with the exclusion of formulations comprising all of a tristyrylphenol-ethoxylate having 6-14 mol ethoxylate, in non-ionic form, and a tristyrylphenol-ethoxylate having 14-18 mol ethoxylate in form of its sulphate or phosphate, in anionic or acid form, and a dialkyl-sulfosuccinate salt is disclosed.

The present invention relates to a novel agrochemical formulation comprising at least two active ingredients and the use thereof.

Agricultural pesticide manufacturers have identified the need for broad-spectrum pesticidal products. Single active ingredient formulations rarely meet such broad-spectrum requirements, and thus combination products, perhaps containing up to four complementary biologically active ingredients, have been developed. Such products have several additional advantages e.g. elimination of tank mixing; reduction in inventory products; saving in time and money; and a reduction in the number of times the crop is sprayed.

The development of such products is relatively simple providing that the active ingredients to be combined are physically, chemically and biologically compatible. In these situations the active ingredients can be combined in a broad range of formulation types well known in the art. Where the active ingredients are not physically, chemically and/or biologically compatible, it has been necessary to develop novel compositions to overcome the problems associated with such incompatibilities. One example of a formulation type is the so-called ‘suspoemulsion’ formulation. These suspoemulsion formulations are formed by combining an emulsion phase, containing one or more active ingredients, with a continuous phase also containing one or more active ingredients in the form of a solid dispersion. This type of formulation has several user advantages related to ease of transportation, storage and field application.

However, the formation of such suspoemulsion formulations is rarely straightforward. The technical challenge and complexity to formulate suspoemulsion formulations with satisfactory physical and chemical stability has been previously reported (e.g. Suspoemulsion Technology and Trends, Joseph R. Winkle, Pesticide Formulation and Adjuvant Technology, CRC Press, 1996).

Particular problems were encountered when attempting to formulate the active ingredients of the present invention into a suspoemulsion. One of the preferred active ingredients used is mesotrione (2-(2′-nitro-4′-methylsulphonylbenzoyl)-1,3-cyclohexanedione), which may be present either as the free acid, or as a metal salt. Mesotrione free acid is chemically unstable in aqueous medium under a range of pH conditions and/or concentration. The problem of the chemical instability may be overcome by chelating the mesotrione free acid with a metal chelating agent, for example a copper or zinc salt. However, the introduction of the metal salt into the composition surprisingly led to severe complications with the physical stability of the resulting suspoemulsion. In some cases it was noted that the chelated mesotrione particles were migrating into the emulsion phase—leading to heteroflocculation/coagulation. In other cases direct heteroflocculation occurred. Depending on the surfactant system, this heteroflocculation/coagulation could happen instantaneously on a macroscopic scale or very slowly, only under stress at a microscopic scale. This was considered very abnormal behaviour as it appeared that the event was not just a flocculation (surface to surface) event, but rather an actual migration of the mesotrione to the inside of the emulsion droplet.

It is therefore an object of the present invention to provide a chemically and physically stable suspoemulsion formulation that comprises an HPPD-inhibiting herbicide as one of the active ingredients.

WO2004/080178 discloses a suspoemulsion formulation comprising a 2-(substituted benzoyl)-1,3-cyclohexanedione herbicide and a chloroacetamide; however, the formulations disclosed require the presence of a polymeric stabilizer. The present invention makes the use of a polymeric stabilizer unnecessary.

Accordingly, a first aspect of the invention provides a chemically and physically stable suspoemulsion formulation, free from polymeric stabilisers having a molecular weight of between 10,000 and 1,000,000 daltons, comprising:

(i) a continuous phase,

(ii) an HPPD-inhibiting herbicide insoluble in the continuous phase,

(iii) a chloroacetamide, and

(iv) one or more aromatic ethoxylate compounds or derivatives thereof with the exclusion of formulations comprising all of a tristyrylphenol-ethoxylate having 6-14 mol ethoxylate, in non-ionic form, and a tristyrylphenol-ethoxylate having 14-18 mol ethoxylate in form of its sulphate or phosphate, in anionic or acid form, and a dialkyl-sulfosuccinate salt.

The continuous phase may be any suitable solvent, for example water, glycol or alcohol, but is preferably water.

In one embodiment of the invention, the HPPD-inhibiting herbicide is a triketone, for example a 2-(substituted benzoyl)-1,3-cyclohexanedione compound of formula (I)

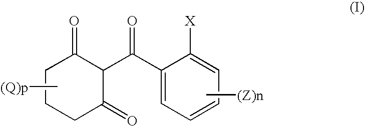

wherein X represents a halogen atom; a straight- or branched-chain alkyl or alkoxy group containing up to six carbon atoms which is optionally substituted by one or more groups —OR¹ or one or more halogen atoms; or a group selected from nitro, cyano, —CO₂R², —S(O)ₘR¹, —O(CH₂)ᵣOR¹, —COR², —NR²R³, —SO₂NR₂R³, —CONR²R³, —CSNR²R³ and —OSO₂R⁴;

R¹ represents a straight- or branched-chain alkyl group containing up to six carbon atoms which is optionally substituted by one or more halogen atoms;

R¹ and R³ each independently represents a hydrogen atom; or a straight- or branched-chain alkyl group containing up to six carbon atoms which is optionally substituted by one or more halogen atoms;

R⁴ represents a straight- or branched-chain alkyl, alkenyl or alkynyl group containing up to six carbon atoms optionally substituted by one or more halogen atoms; or a cycloalkyl group containing from three to six carbon atoms;

each Z independently represents halo, nitro, cyano, S(O)ₘR⁵, OS(O)ₘR⁵, C₁₋₆ alkyl, C₁₋₆ alkoxy, C₁₋₆ haloalkyl, C₁₋₆ haloalkoxy, carboxy, C₁₋₆ alkylcarbonyloxy, C₁₋₆ alkoxycarbonyl, C₁₋₆ alkylcarbonyl, amino, C₁₋₆ alkylamino, C₁₋₆ dialkylamino having independently the stated number of carbon atoms in each alkyl group, C₁₋₆ alkylcarbonylamino, C₁₋₆ alkoxycarbonylamino, C₁₋₆ alkylaminocarbonylamino, C₁₋₆ dialkylaminocarbonylamino having independently the stated number of carbon atoms in each alkyl group, C₁₋₆ alkoxycarbonyloxy, C₁₋₆ alkylaminocarbonyloxy, C₁₋₆ dialkylcarbonyloxy, phenylcarbonyl, substituted phenylcarbonyl, phenylcarbonyloxy, substituted phenylcarbonyloxy, phenylcarbonylamino, substituted phenylcarbonylamino, phenoxy or substituted phenoxy;

R⁵ represents a straight- or branched-chain alkyl group containing up to six carbon atoms which is optionally substituted by one or more halogen atoms;

each Q independently represents C₁₋₄ alkyl or —CO₂R⁶ wherein R⁶ is C₁₋₄ alkyl;

m is zero, one or two;

n is zero or an integer from one to four;

r is one, two or three; and

p is zero or an integer from one to six.

Suitably, X is chloro, bromo, nitro, cyano, C₁₋₄ alkyl, —CF₃, —S(O)ₘR¹, or —OR¹; each Z is independently chloro, bromo, nitro, cyano, C₁₋₄ alkyl, —CF₃, —OR¹, —OS(O)ₘR⁵ or —S(O)ₘR⁵; n is one or two; and p is zero.

Preferably, the 2-(substituted benzoyl)-1,3-cyclohexanedione of formula (I) is selected from the group consisting of 2-(2′-nitro-4′-methylsulphonylbenzoyl)-1,3-cyclohexanedione, 2-(2′-nitro-4′-methylsulphonyloxybenzoyl)-1,3-cyclohexanedione, 2-(2′-chloro-4′-methylsulphonylbenzoyl)-1,3-cyclohexanedione, 4,4-dimethyl-2-(4-methanesulphonyl-2-nitrobenzoyl)-1,3-cyclohexanedione, 2-(2-chloro-3-ethoxy-4-methanesulphonylbenzoyl)-5-methyl-1,3-cyclohexanedione and 2-(2-chloro-3-ethoxy-4-ethanesulphonylbenzoyl)-5-methyl-1,3-cyclohexanedione; most preferably is 2-(2′-nitro-4′-methylsulphonylbenzoyl)-1,3-cyclohexanedione:

The 2-(substituted benzoyl)-1,3-cyclohexanedione may be present in either the acid (non-chelated form) or as the metal chelated form. The metal chelated form of the 2-(substituted benzoyl)-1,3-cyclohexanedione may be made by adding a metal stabilizing salt to the suspoemulsion formulation. Examples of suitable stabilizing metal salts that may be used include calcium, beryllium, barium, titanium, magnesium, manganese, zinc, iron, cobalt, nickel and copper salts; most suitable are magnesium, manganese, zinc, iron, cobalt, nickel and copper salts; especially preferred is a copper salt, for example copper hydroxide. Suitably, the concentration of stabilizing metal salts in the suspoemulsion formulation of the invention is from 0.01 to 4.0%, and preferably from 0.02 to 1.5%.

In a second embodiment of the invention, the HPPD-inhibiting herbicide is an isoxazole compound of formula (II)

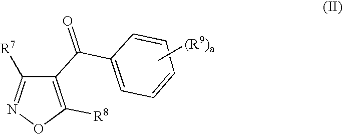

wherein R⁷ is hydrogen or —CO₂R¹⁰;

R⁸ is C₁₋₄ alkyl or C₃₋₆ cycloalkyl optionally substituted by C₁₋₆ alkyl;

R⁹ is independently selected from halogen, nitro, cyano, C₁₋₄ alkyl, C₁₋₄ haloalkyl, C₁₋₆ alkoxy, C₁₋₄haloalkoxy, —(CR¹¹R¹²)_{c}S(O)_{b}R¹³, —S(O)_{b}R¹³, —OSO₂R¹³ and —N(R¹⁴)SO₂R¹³;

or two groups R⁹, on adjacent carbon atoms of the phenyl ring may, together with the carbon atoms to which they are attached, form a 5- or 6-membered saturated or unsaturated heterocyclic ring containing up to three ring heteroatoms selected from nitrogen, oxygen and sulphur, which ring may be optionally substituted by one or more groups selected from halogen, nitro, C₁₋₄ alkyl, C₁₋₄ alkoxy, C₁₋₄ haloalkyl, C₁₋₄ haloalkoxy and —S(O)_{b}R¹³, it being understood that a sulphur atom, where present in the ring, may be in the form of a group —SO— or —SO₂—;

R¹⁰ is C₁₋₄ alkyl;

R¹¹ and R¹² are independently hydrogen or C₁₋₄ alkyl;

R¹³ is C₁₋₄, alkyl, or phenyl or benzyl, each of phenyl and benzyl optionally bearing from one or five substituents which may be the same or different selected from the group consisting of halogen, C₁₋₄ alkyl, C₁₋₄ alkoxy, C₁₋₄ haloalkyl, C₁₋₄haloalkoxy, nitro and —S(O)_{b}CH₃;

R¹⁴ is hydrogen or C₁₋₆ alkyl;

a is an integer from one to five;

b is zero, one or two; and

c is one or two (where c is two, the groups (CR¹¹R¹²) may be the same or different.

Suitably R⁷ is hydrogen; R⁸ is cyclopropyl; R⁹ is halogen (preferably chloro), —S(O)_{b}CH₃, or C₁₋₄ haloalkyl (preferably trifluoromethyl); and a is two.

Particularly preferred compounds of formula (IA) are selected from the group consisting of 5-cyclopropyl-4-(2-methylsulfonyl-4-trifluoromethyl)benzoyl isoxazole (isoxaflutole) and 4-(2-chloro-4-methylsulphonyl)benzoyl-5-cyclopropylisoxazole (isoxachlortole).

In a third embodiment of the invention, the HPPD-inhibiting herbicide is a compound of formula (III) 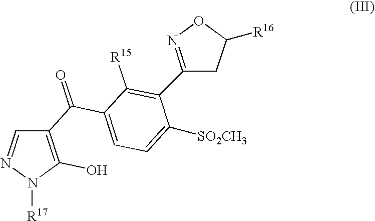
wherein R¹⁵ is C₁₋₂ alkyl or chloro; R¹⁶ is hydrogen or C₁₋₄ alkyl; and R¹⁷ is C₁₋₄ alkyl.

Suitably, the chloroacetamide suitable for use in the present invention includes compounds of formula (IV)

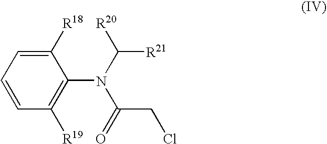

wherein R¹⁸ is hydrogen, methyl or ethyl; R¹⁹ is hydrogen or ethyl; R²⁰ is hydrogen or methyl; and R²¹ is methyl, methoxy, methoxymethyl, ethoxy, or butoxy.

Suitably, the chloroacetamide is selected from the group consisting of metolachlor, acetochlor and alachlor, preferably metolachlor, and most preferably, s-metolachlor.

Suitably, the one or more aromatic ethoxylate compounds are selected from di- or tri-styrylphenol ethoxylates and their derivates, such as phosphates and sulphates and salts thereof. Examples of the one or more di- or tri-styrylphenol ethoxylates or derivatives thereof include, but are not limited to, ethoxylated tristyrylphenol, sulphates and phosphates of polyarylphenol ethoxylates. These sulphates and phosphates being used either in their acid forms, or as salts, such as ammonium, triethanolamine, etc. Examples of such products include: Soprophor BSU', ‘Soprophor S25’, Soprophor TS/10, Soprophor 4D384, Soprophor 3D33, Soprophort FL, etc.

The concentration of HPPD-inhibiting herbicide in the formulation is suitably from 10 g a.i./litre to 200 g a.i./litre, preferably from 25 g ai./litre to 100 g ai./litre. The concentration of chloroacetamide in the formulation is suitably from 100 g a.i./litre to 800 g a.i./litre, preferably from 250 g a.i./litre to 600 g a.i./litre. The concentration of ethoxylate in the suspoemulsion formulation is suitably from 5 g a.i./litre to 150 g a.i./litre, preferably from 10 g a.i./litre to 75 g a.i./litre. Suitably, the formulation comprises at least 300 g/litre of total a.i.

Whilst any pH may be appropriate for the formulations of the invention, a pH in the acidic range is considered preferable, and most preferably the formulation has a pH of 5 or less.

The suspoemulsion formulation of the present invention may also optionally comprise one or more additional active ingredients. The one or more additional active ingredients may be a pesticide, for example a herbicide, fungicide, insecticide or the like; or the additional active ingredient may be a compound selected from the class of compounds known as safeners or antidotes. The concentration of additional active ingredient in the formulation is suitably in the range of from 1 g/l to 500 g/l, and preferably from 2 g/l to 300 g/l

In a further embodiment of the invention, the suspoemulsion formulation further comprises an additional active ingredient which is a herbicide, for example a herbicide selected from the class known as triazines, for example atrazine or terbuthylazine; a phosphonate herbicide, for example glyphosate or salts thereof; or a phosphinate herbicide, such as glufosinate or salts thereof. The concentration of additional herbicide is suitably in the range of from 5 g/l to 500 g/l, and preferably from 10 g/l to 300 g/l. Most preferably, the additional herbicide is a triazine, preferably atrazine or terbuthylazine.

In a still further embodiment of the invention, the suspoemulsion formulation comprises an additional active ingredient selected from the class of compounds known as safeners or antidotes, for example benoxacor, or dichlormid. The concentration of safener is suitably in the range of from 1 g/l to 100 g/l, and preferably from 2 g/l to 40 g/l.

In a yet further embodiment of the invention, the suspoemulsion formulation further comprises at least two additional active ingredients, wherein at least one of the additional active ingredients is a herbicide, for example a triazine, such as atrazine or terbuthylazine, and at least one of the other additional active ingredients is a safener, for example benoxacor or dichlormid.

The suspoemulsion formulation of the present invention may also optionally comprise an electrolyte component. By the term ‘electrolyte component’, we mean a compound which produces ions when in solution, for example a salt of an alkali metal, such as sodium, or alkaline earth metal, such as magnesium. In one preferred embodiment, the salt is a chloride salt, for example magnesium chloride. In a second preferred embodiment, the salt is a nitrate salt, for example ammonium nitrate. Suitably, the concentration of electrolyte in the suspoemulsion formulation of the invention is from 0.1 to 200 g/l, and suitably from 1 to 50 g/l, and preferably less than 10 g/l.

Other formulation components as appropriate may be included in the suspoemulsion. Such other components may include none, some or all of the following: crystallization inhibitors, viscosity modifiers, spray droplet modifiers, pigments, antioxidants, foaming agents, light-blocking agents, antifoam agents, sequestering agents, neutralizing agents, buffers, corrosion inhibitors, dyes, odorants, thickening agents and freezing point depressants, for obtaining special effects.

In a further aspect of the invention, there is provided a method for controlling the growth of undesirable vegetation such as weeds, which may be present around the locus of a desired plant species (which may or may not exhibit resistance, either by natural means or by genetic modification, to one or more herbicides), e.g. a crop such as corn, which comprises applying the formulation of the invention to the locus of such undesirable vegetation. Examples of undesirable vegetation include, but are not limited to, velvetleaf, redroot pigweed, common water hemp, Palmer amaranth, ivyleaf morning glory, prickly sida, giant ragweed, common ragweed, common cocklebur, Eastern black nightshade, common lambsquarters, Pennsylvania smartweed, common sunflower, jimsonweed, hemp sesbania, toothed spurge, common purslane, large crabgrass, yellow foxtail and kochia. The weeds may or may hot demonstrate resistance (either naturally or genetically modification) to one or more herbicides. The suspoemulsion formulation may be applied pre-emergence or post-emergence of the crop. Preferably, the formulation is applied pre-emergent. The formulation may be applied by air or on the ground by known techniques, such as hydraulic nozzle spray.

One advantage of the suspoemulsion formulation of the present invention is that, under the majority of conditions, season-long control of weeds is obtained by just one application of the formulation.

The invention will now be described by way of example only.

Description of Products Used in the Examples

| Component | Description |
|---|---|
| Soprophor BSU (Rhodia) | Tristyrylphenol with 16 moles EO |
| Soprophor S/25 (Rhodia) | Tristyrylphenol polyglycolether EO 25 |
| Soprophor 4 D 384 | Ethoxylated tristyrylphenol sulphate, |
| (Rhodia) | ammonium salt |
| Berol 922 (Akzo Nobel) | Nonylphenol copolymer 20 PO/25-30 EO |
| Soprophor FL (Rhodia) | Tristyrylphenol-polyglycolether- |
| | phosphate triethanolamine salt |
| Atlox G 5000 (Uniqema) | Copolymer butanol PO/EO |
| NANSA EVM63/B | Dodecyl-benzene sulfonic acid Ca-salt |
| (Huntsman) | linear solvent sol. |
| Isopar L | Isoparaffinic solvent |
| (Exxon Chemical) | |
| Proxel GXL (Avecia) | 1,2-benzisothiazolin-3-one in sol. |
| | approx. 20% |
| Attagel 50 | Attapulgite clay (magnesium aluminium |
| (Engelhard Corp.) | silicate) |
| Kelzan (Kelko) | Heteropolysaccharide |
| Antifoam MSA | Polydimethylsiloxane |
| (Dow Corning) | |
| Silicon oil DB 100 | |
| compound (DOW Corning) | |

EO = ethylene oxide;
PO = propylene oxide.

### EXAMPLE 1

### 1.1 Preparation of Premixes

1.1.1 Preparation of S-Metolachlor Oil Phase

| | % wt |
|---|---|
| S-metolachlor | 75.0 |
| Isopar L | 15.0 |
| NANSA EVM63/B | 5.0 |
| ATLOX G 5000 | 5.0 |

First charge s-Metolachlor; add NANSA EVM63/B, Atlox G5000 (preheated to 50-60° C.) and Isopar L. Mix until dissolved.

1.1.2 Preparation of Mesotrione Millbase

| | % wt |
|---|---|
| Mesotrione | 35.00 |
| Soprophor S/25 | 3.50 |
| Acetic Acid (80%) | 7.73 |
| Copper hydroxide (100%) | 5.05 |
| Antifoam MSA | 0.10 |
| Kelzan | 0.10 |
| Ammonium nitrate (60%) | 4.30 |
| Water | rest |

Mix together the water, acetic acid and copper hydroxide. Add the mesotrione. The ammonium nitrate solution, the Soprophor S/25 (surfactant), Antifoam MSA and the Kelzan are added and mixed until uniform. The slurry was ground to a median particle size of less than 2.5 microns.

### 1.2 Preparation of Final Formulation

| | % wt |
|---|---|
| Mesotrione Millbase | 15.95 |
| S-Metolachlor oil phase | 62.0 |
| Kelzan | 0.02 |
| Propylene glycol | 4.65 |
| Proxel GXL | 0.19 |
| Silicon oil DB 100 compound | 0.09 |
| Attagel 50 | 1.40 |
| Water | rest |

First charge water, add propylene glycol and Mesotrione millbase and mix until uniform. Add the Proxel GXL (preservative), Silicon oil DB 100 compound (antifoam agent) and thickener gels (Kelzan gel and Attagel 50 in form of aqueous gel containing the clay and tetra sodium pyrophosphate) under agitation. Slowly add the oil phase in such a way as to form an emulsified organic phase.

### EXAMPLE 2

### 2.1 Preparation of Premixes

2.1.1 Preparation of S-metolachlor Oil Phase (see 1.1.1)

2.1.2 Preparation of Mesotrione Millbase

| | % wt |
|---|---|
| Mesotrione | 35.00 |
| Berol 922 | 5.70 |
| Acetic Acid (80%) | 7.73 |
| Copper Hydroxide (100%) | 5.05 |
| Antifoam MSA | 0.10 |
| Kelzan | 0.10 |
| Ammonium nitrate (60%) | 4.30 |
| Water | rest |

Mix together the water, acetic acid and copper hydroxide. Add the mesotrione. The ammonium nitrate, the Berol 922 (non-ionic surfactant), the Antifoam MSA and the Kelzan are added and mixed until uniform. The slurry was ground to a median particle size of less than 2.5 microns.

### 2.2 Preparation of Final formulation

| | % wt |
|---|---|
| Mesotrione millbase | 15.95 |
| S-metolachlor oil phase | 62.0 |
| Kelzan | 0.02 |
| Propylene glycol | 4.65 |
| Proxel GXL | 0.19 |
| Silicon oil DB 100 compound | 0.09 |
| Attagel 50 | 1.40 |
| Water | rest |

First charge water, add propylene glycol and mesotrione millbase and mix until uniform. Add the Proxel GXL (preservative), Silicon oil DB 100 compound (antifoam agent) and thickener gels (Kelzan gel and Attagel 50 in form of aqueous gel containing the clay and tetra sodium pyrophosphate) under agitation. Slowly add the oil phase in such a way as to form an emulsified organic phase.

### EXAMPLE 3

### 3.1 Preparation of Premixes

3.1.1 Preparation of S-metolachlor Oil Phase (see 1.1.1)

3.1.2 Preparation of Mesotrione Millbase

| | % wt |
|---|---|
| Mesotrione | 25.00 |
| Soprophor BSU | 5.70 |
| Acetic acid (80%) | 7.70 |
| Copper hydroxide (100%) | 3.6 |
| Antifoam MSA | 0.10 |
| Kelzan | 0.10 |
| Water | rest |

Mix together the water, acetic acid and copper hydroxide. Add the mesotrione, the Soprophor BSU (surfactant), Antifoam MSA and Kelzan and mix until uniform. The slurry was ground to a median particle size of less than 2.5 microns.

### 3.2 Preparation of Final Formulation

| | % wt |
|---|---|
| Mesotrione Millbase | 22.3 |
| S-metolachlor oil phase | 62.0 |
| Kelzan | 0.02 |
| Propylene glycol | 4.65 |
| Proxel GXL | 0.19 |
| Silicon oil DB 100 compound | 0.09 |
| Attagel 50 | 1.40 |
| Water | rest |

First charge water, add propylene glycol and mesotrione millbase and mix until uniform. Add the Proxel GXL (preservative), Silicon oil DB 100 compound (antifoam agent) and thickener gels (Kelzan gel and Attagel 50 in form of aqueous gel containing the clay and tetra sodium pyrophosphate) under agitation. Slowly add the oil phase in such a way as to form an emulsified organic phase.

### EXAMPLE 4

### 4.1 Preparation of Premixes

4.1.1 Preparation of S-metolachlor Oil Phase (see 1.1.1)

4.1.2 Preparation of Mesotrione Millbase

| | % wt |
|---|---|
| Mesotrione | 35.00 |
| Soprophor 4 D384 | 5.70 |
| Acetic acid (80%) | 7.73 |
| Copper hydroxide (100%) | 5.05 |
| Antifoam MSA | 0.10 |
| Kelzan | 0.10 |
| Ammonium nitrate (60%) | 4.30 |
| Water | rest |

Mix together the water, acetic acid and copper hydroxide. Add the mesotrione. The ammonium nitrate, Soprophor 4 D384 (ionic surfactant), Antifoam MSA and Kelzan are added and mixed until uniform. The slurry is ground to a median particle size of less than 2.5 microns.

### 4.2 Preparation of Final Formulation

| | % wt |
|---|---|
| Mesotrione Millbase | 15.95 |
| S-metolachlor oil phase | 62.0 |
| Kelzan | 0.02 |
| Propylene glycol | 4.65 |
| Proxel GXL | 0.19 |
| Silicon oil DB 100 compound | 0.09 |
| Attagel 50 | 1.40 |
| Water | rest |

First charge water, add propylene glycol and mesotrione millbase and mix until uniform. Add the Proxel GXL (preservative), Silicon oil DB 100 compound (antifoam agent) and thickener gels (Kelzan gel and Attagel in form of aqueous gel containing the clay and tetra sodium pyrophosphate) under agitation. Slowly add the oil phase in such a way as to form an emulsified organic phase.

### EXAMPLE 5

### 5.1 Preparation of Premixes

5.1.1 Preparation of S-metolachlor Oil Phase (see 1.1.1)

5.1.2 Preparation of Mesotrione Millbase

| | % wt |
|---|---|
| Mesotrione | 25.00 |
| Soprophor FL | 5.70 |
| Acetic Acid (80%) | 7.70 |
| Copper hydroxide (100%) | 3.6 |
| Antifoam MSA | 0.10 |
| Kelzan | 0.10 |
| Water | rest |

Mix together the water, acetic acid and copper hydroxide. Add the mesotrione. The Soprophor FL (surfactant), Antifoam MSA and the Kelzan are added and mixed until uniform. The slurry was ground to a median particle size of less than 2.5 microns.

### 5.2 Preparation of Final Formulation

| | % wt |
|---|---|
| Mesotrione Millbase | 22.3 |
| S-metolachlor oil phase | 62.0 |
| Kelzan | 0.02 |
| Propylene glycol | 4.65 |
| Proxel GXL | 0.19 |
| Silicon oil DB 100 compound | 0.09 |
| Attagel 50 | 1.40 |
| Water | rest |

First charge water, add propylene glycol and Mesotrione millbase and mix until uniform. Add the Proxel GXL (preservative), Silicon oil DB 100 compound (antifoam agent) and thickener gels (Kelzan gel and Attagel in form of aqueous gel containing the clay and tetra sodium pyrophosphate under agitation. Slowly add the oil phase in such a way as to form an emulsified organic phase.

1. A chemically and physically stable suspoemulsion formulation, free from polymeric stabilisers having a molecular weight of between 10,000 and 1,000,000 daltons, comprising:
(i) a continuous phase,
(ii) an HPPD-inhibiting herbicide insoluble in the continuous phase,
(iii) a chloroacetamide, and
(iv) one or more aromatic ethoxylate compounds or derivatives thereof
with the exclusion of formulations comprising all of a tristyrylphenol-ethoxylate having 6-14 mol ethoxylate, in non-ionic form, and a tristyrylphenol-ethoxylate having 14-18 mol ethoxylate in form of its sulphate or phosphate, in anionic or acid form, and a dialkyl-sulfosuccinate salt.

2. A suspoemulsion formulation according to claim 1, wherein the continuous phase is selected from the group consisting of water, glycol or alcohol.

3. A suspoemulsion formulation according to claim 1, wherein the HPPD-inhibiting herbicide is a compound of formula (I) 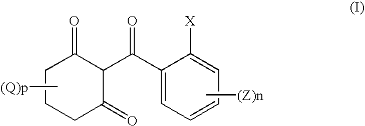
wherein X represents a halogen atom; a straight- or branched-chain alkyl or alkoxy group containing up to six carbon atoms which is optionally substituted by one or more groups —OR¹ or one or more halogen atoms; or a group selected from nitro, cyano, —CO₂R², —S(O)ₘR¹, —O(CH₂)ᵣOR¹, —COR², —NR²R³, —SO₂NR₂R³, —CONR²R³, —CSNR²R³ and —OSO₂R⁴;
R¹ represents a straight- or branched-chain alkyl group containing up to six carbon atoms which is optionally substituted by one or more halogen atoms;
R² and R³ each independently represents a hydrogen atom; or a straight- or branched-chain alkyl group containing up to six carbon atoms which is optionally substituted by one or more halogen atoms;
R⁴ represents a straight- or branched-chain alkyl, alkenyl or alkynyl group containing up to six carbon atoms optionally substituted by one or more halogen atoms; or a cycloalkyl group containing from three to six carbon atoms;
each Z independently represents halo, nitro, cyano, S(O)ₘR⁵, OS(O)ₘR⁵, C₁₋₆alkyl, C₁₋₆ alkoxy, C₁₋₆ haloalkyl, C₁₋₆ haloalkoxy, carboxy, C₁₋₆ alkylcarbonyloxy, C₁₋₆ alkoxycarbonyl, C₁₋₆ alkylcarbonyl, amino, C₁₋₆ alkylamino, C₁₋₆ dialkylamino having independently the stated number of carbon atoms in each alkyl group, C₁₋₆alkylcarbonylamino, C₁₋₆alkoxycarbonylamino, C₁₋₆ alkylaminocarbonylamino, C₁₋₆ dialkylaminocarbonylamino having independently the stated number of carbon atoms in each alkyl group, C₁₋₆alkoxycarbonyloxy, C₁₋₆alkylaminocarbonyloxy, C₁₋₆ dialkylcarbonyloxy, phenylcarbonyl, substituted phenylcarbonyl, phenylcarbonyloxy, substituted phenylcarbonyloxy, phenylcarbonylamino, substituted phenylcarbonylamino, phenoxy or substituted phenoxy;
R⁵ represents a straight- or branched-chain alkyl group containing up to six carbon atoms which is optionally substituted by one or more halogen atoms; each Q independently represents C₁₋₄ alkyl or —CO₂R⁶ wherein R⁶ is C₁₋₄ alkyl;
m is zero, one or two;
n is zero or an integer from one to four;
r is one, two or three; and
p is zero or an integer from one to six.

4. A suspoemulsion formulation according to claim 3, wherein X is chloro, bromo, nitro, cyano, C₁-C₄ alkyl, —CF₃, —S(O)ₘR¹, or —OR¹; each Z is independently chloro, bromo, nitro, cyano, C₁-C₄ alkyl, —CF₃, —OR¹, —OS(O)ₘR⁵ or —S(O)ₘR⁵; n is one or two; and p is zero.

5. A suspoemulsion formulation according to claim 3, wherein the 2-(substituted benzoyl)-1,3-cyclohexanedione of formula (I) is selected from the group consisting of 2-(2′-nitro-4′-methylsulphonyl benzoyl)-1,3-cyclohexanedione, 2-(2′-nitro-4′-methylsulphonyloxybenzoyl)-1,3-cyclohexanedione, 2-(2′-chloro-4′-methylsulphonylbenzoyl)-1,3-cyclohexanedione, 4,4-dimethyl-2-(4-methanesulphonyl-2-nitrobenzoyl)-1,3-cyclohexanedione, 2-(2-chloro-3-ethoxy-4-methanesulphonyl benzoyl)-5-methyl-1,3-cyclohexanedione and 2-(2-chloro-3-ethoxy-4-ethanesulphonylbenzoyl)-5-methyl-1,3-cyclohexanedione.

6. A suspoemulsion formulation according to claim 5, wherein the 2-(substituted benzoyl)-1,3-cyclohexanedione is 2-(2′-nitro-4′-methylsulphonyl benzoyl)-1,3-cyclohexanedione.

7. A suspoemulsion formulation according to claim 1, wherein the HPPD-inhibiting herbicide is an isoxazole compound of formula (II) 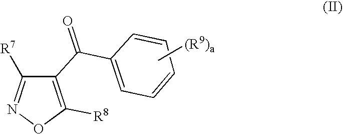
wherein R⁷ is hydrogen or —CO₂R¹⁰;
R⁸ is C₁₋₄ alkyl or C₃₋₆ cycloalkyl optionally substituted by C₁₋₆ alkyl;
R⁹ is independently selected from halogen, nitro, cyano, C₁₋₄ alkyl, C₁₋₄ haloalkyl, C₁₋₆ alkoxy, C₁₋₄ haloalkoxy, —(CR¹¹R¹²)_{c}S(O)_{b}R¹³, —S(O)_{b}R¹³, —OSO₂R¹³ and —N(R¹⁴)SO₂R¹³;
or two groups R⁹, on adjacent carbon atoms of the phenyl ring may, together with the carbon atoms to which they are attached, form a 5- or 6-membered saturated or unsaturated heterocyclic ring containing up to three ring heteroatoms selected from nitrogen, oxygen and sulphur, which ring may be optionally substituted by one or more groups selected from halogen, nitro, C₁₋₄ alkyl, C₁₋₄ alkoxy, C₁₋₄ haloalkyl, C₁₋₄ haloalkoxy and —S(O)_{b}R¹³, it being understood that a sulphur atom, where present in the ring, may be in the form of a group —SO— or —SO₂—;
R¹⁰ is C₁₋₄ alkyl;
R¹¹ and R¹² are independently hydrogen or C₁₋₄ alkyl;
R¹³ is C₁₋₄ alkyl, or phenyl or benzyl, each of phenyl and benzyl optionally bearing from one or five substituents which may be the same or different selected from the group consisting of halogen, C₁₋₄ alkyl, C₁₋₄ alkoxy, C₁₋₄ haloalkyl, C₁₋₄ haloalkoxy, nitro and —S(O)_{b}CH₃;
R¹⁴ is hydrogen or C₁₋₆ alkyl;
a is an integer from one to five;
b is zero, one or two; and
c is one or two (where c is two, the groups (CR¹¹R¹²) may be the same or different.

8. A suspoemulsion formulation according to claim 7 wherein R⁷ is hydrogen; R³ is cyclopropyl; R⁹ is halogen (preferably chloro), —S(O)_{b}CH₃, or C₁₋₄ haloalkyl (preferably trifluoromethyl); and a is two.

9. A suspoemulsion formulation according to claim 7, wherein the isoxazole compound is selected from the group consisting of 5-cyclopropyl-4-(2-methylsulfonyl-4-trifluoromethyl)benzoylisoxazole (isoxaflutole) and 4-(2-chloro-4-methylsulphonyl)benzoyl-5-cyclopropylisoxazole (isoxachlortole).

10. A suspoemulsion formulation according to claim 1, wherein the HPPD-inhibiting herbicide is a compound of formula (III) 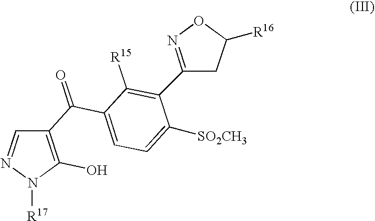
wherein R¹⁵ is C₁₋₂ alkyl or chloro; R¹⁶ is hydrogen or C₁₋₄ alkyl; and R¹⁷ is C₁₋₄ alkyl.

11. A suspoemulsion formulation according to claim 1, wherein the chloroacetamide is a compound of formula (IV) 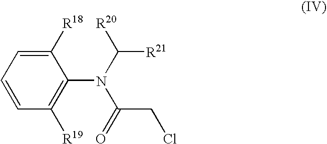
wherein R¹⁸ is hydrogen, methyl or ethyl; R¹⁹ is hydrogen or ethyl; R²⁰ is hydrogen or methyl; and R²¹ is methyl, methoxy, methoxymethyl, ethoxy, or butoxy.

12. A suspoemulsion formulation according to claim 1, wherein the aromatic ethoxylate compound is selected from the group consisting of di- or tri-styrylphenol ethoxylates, and phosphates, sulphates and salts thereof.

13. A suspoemulsion formulation according to claim 1, wherein the formulation has a pH of 5 or less.

14. A suspoemulsion formulation according to claim 1, wherein the formulation further comprises one or more additional active ingredients selected from the group consisting of herbicides, fungicides, insecticides, safeners or antidotes.

15. A suspoemulsion formulation according to claim 14, wherein the additional active ingredient is a triazine herbicide.

16. A suspoemulsion formulation according to claim 14 wherein the additional active ingredient is a safener or antidote.

17. A suspoemulsion formulation according to claim 14, wherein the additional active ingredient comprises at least a triazine herbicide and a safener or antidote compound.

18. A suspoemulsion formulation according to claim 1, wherein the formulation further comprises an electrolyte.

19. A method for controlling the growth of undesirable vegetation comprising applying to the locus of said undesirable vegetation a suspoemulsion formulation according to claim 1.
